(19) United States
(12) Patent Application Publication
(10) Pub. No.: US 2024/0194935 A1
(43) Pub. Date: Jun. 13, 2024

(54) COMPOSITION FOR FORMING CERAMIC ELECTROLYTE, AND RESULTING ELECTROLYTE

(71) Applicant: Lina Energy Ltd., Lancaster (GB)

(72) Inventors: Richard Dawson, Lancaster (GB); Gene Lewis, Lancaster (GB); Joana Filipa Gingeira Jardim de Azevedo, Lancaster (GB)

(21) Appl. No.: 18/284,983

(22) PCT Filed: Mar. 25, 2022
(86) PCT No.: PCT/GB2022/050758

§ 371 Date: Sep. 29, 2023

(30) Foreign Application Priority Data
Mar. 29, 2021 (GB) 2104429.2

(51) Int. Cl. H01M 10/0562; H01M 10/054; H01M 50/434; H01M 50/457

(52) U.S. Cl. CPC H01M 10/0562; H01M 10/054; H01M 50/434; H01M 50/457; H01M 2300/0071

(57) ABSTRACT

A composition is provided for forming a sodium-ion conducting electrolyte structure, comprising particles of a sodium-ion-conducting ceramic, combined with particles of at least one transition metal oxide, such as copper, titanium and niobium oxides, or iron oxide, or precursors for these oxides, so the metal oxides make up no more than 5% by weight of the weight of the particles. The sodium-ion-conducting ceramic may be of the types referred to as Nasicon, or β″-alumina. The metal oxides may constitute no more than 2% of the weight of the particles. The metal oxides act as a sintering aid, making it possible to achieve densification at a reduced sintering temperature, while having no significant detrimental effect on the electrical properties of the sintered ceramic. The invention also encompasses an electrode structure made by sintering this composition.

The present invention relates to a composition or mixture for forming a ceramic electrolyte for use in an electrochemical cell, and to the resulting electrolyte.

Several different types of electrochemical cell are known that use a ceramic electrolyte. These include cells in which the electrolyte must be at elevated temperature to provide adequate conductivity; and cells in which an electrode must be at elevated temperature for an electrode component to be liquid. One such type of cell is a molten sodium-metal halide rechargeable battery, such as the sodium/nickel chloride cell which may be referred to as a ZEBRA cell (see for example J. L. Sudworth, “The Sodium/Nickel Chloride (ZEBRA) Battery (J. Power Sources 100 (2001) 149-163). A sodium/nickel chloride cell incorporates a liquid sodium negative electrode separated from a positive electrode by a solid electrolyte which conducts sodium ions. The solid electrolyte may for example consist of beta alumina. The positive electrode includes nickel, nickel chloride and sodium tetrachloroaluminate which is liquid during use and acts as a secondary electrolyte to allow transport of sodium ions from the nickel chloride to the solid electrolyte. The positive electrode also incorporates aluminium powder. Partial replacement of the nickel with other transition metals such as iron can result in additional discharge voltage levels. The cell operates at a temperature which is typically below 350° C., but must be above the melting point of the sodium tetrachloroaluminate, which is 157° C., and the operating temperature is typically between 270° and 300° C. During discharge the normal reactions are as follows:

Cathode (positive electrode): NiCl₂+2Na⁺+2e⁻→Ni+2NaCl

Anode (negative electrode): Na→Na⁺+e⁻

the overall result being that anhydrous nickel chloride (in the cathode) reacts with metallic sodium (in the anode) to produce sodium chloride and nickel metal; and the cell voltage is 2.58 V at 300° C.

A modified type of a ZEBRA cell, that is to say a molten sodium-nickel chloride rechargeable cell, is described in WO 2019/073260. This uses an electrolyte element that comprises a perforated sheet of non-reactive metal, and a non-permeable layer of sodium-ion-conducting ceramic bonded to one face of the perforated sheet. In this electrolyte element the strength can therefore be provided by the metal sheet, and this enables the electrolyte thickness to be significantly reduced as compared to that required in a conventional ZEBRA cell. This results in a cell or a battery that can perform adequately at significantly lower temperatures, for example less than 200° C. Furthermore, a significantly thinner layer of ceramic also significantly reduces stresses induced by heating from ambient, so start-up times from ambient can be just a few minutes. These are both commercially advantageous benefits. The non-permeable ceramic layer is deposited on and bonded to the perforated metal sheet, and this bonding may be by a porous ceramic sub-layer. A similar electrolyte is described in GB2019388.4=PCT/GB2021/053215, filed on 9 Dec. 2020, in which a sheet of ceramic acting as electrolyte is in contact with a perforated sheet of metal over substantially its entire area, to provide support to the sheet of ceramic, but in which the ceramic sheet is formed separately, rather than being formed by deposition onto the metal sheet.

A suitable ceramic to conduct sodium ions is that called Nasicon; and another suitable ceramic is alumina, more specifically β″-alumina, which is the β″ phase of Na₂O·5Al₂O₃. An electrolyte of this latter material may be referred to as BASE, “Beta Alumina Solid Electrolyte”. Nasicon is a family of materials, the name being an abbreviation of “Na Super-Ionic CONductor”, which may be represented broadly by the formula NaMP₃O₁₂ where M represents one or more metal ions, with a wide range of possible valencies. Nasicon materials have a structure that consists of a three-dimensional framework of corner-sharing MO₆ octahedra and PO₄ tetrahedra, but the crystal structure depends on the composition. One such material is Na₃Zr₂(SiO₄)₂(PO₄).

Forming an electrolyte structure of β″-alumina or of Nasicon involves forming a layer of particulate material, and sintering to form a coherent structure and to achieve densification. The firing temperatures are above 1200° C. for Nasicon and typically 1600° C. for β″-alumina. It would be desirable if sintering and densification could be achieved at a lower temperature, as temperatures below 1100° C. are more compatible with high-temperature stainless steels, and temperatures below 1200° C. reduce both the capital cost and the running cost of the furnace. Furthermore, processing at elevated temperatures above 1200° ° C. can result in distortion of the ceramic layer or of a substrate on which it is formed, and if the furnace operates at above 1400° C. this problem becomes worse. It is imperative the layers remain flat for efficient performance, packing and sealing within a cell. Any such distortion may necessitate additional processing such as grinding, cutting and polishing, which would increase production costs and introduce variability owing to the brittle nature of the materials. Importantly, firing at temperatures at or below 1200° C. would negate the need for any post-sintering mechanical interaction with the sodium ion conducting layer.

According to the present invention there is provided a composition for forming a sodium-ion conducting electrolyte structure, comprising particles of a sodium-ion-conducting ceramic, and particles of at least one transition metal oxide, or at least one precursor for a transition metal oxide, so the transition metal oxide or oxides make up no more than 5% by weight of the weight of the particles.

The composition is thus a mixture of these two types of particles: particles of the sodium-ion-conducting ceramic, and a small proportion of particles of transition metal oxide (or a precursor). The or each transition metal oxide acts as a sintering aid, so lowering the temperature required to densify the particles of the sodium-ion-conducting ceramic. The transition metals may comprise copper, titanium and/or niobium. Other transition metals that may be used are hafnium, scandium, cobalt or vanadium. Another suitable transition metal is iron.

The use of sintering aids in ceramics is well known. Typically, the addition of sintering aids lowers the sintering temperature but has a material interaction that can substantially alter the properties of the host material. The present invention provides sintering aids that significantly lower the sintering temperature of both β″-alumina and NASICON and, importantly, do not impair the sodium-ion vacancy structure within the ceramic. Hence they do not diminish the ionic conductivity of the densified ceramic. Furthermore, the method of adding these sintering aids into the sodium-ion conducting host has negligible impact on the methodologies used to develop thick films of the sodium-ion conducting material. Such methods include, but are not limited to, screen printing, spraying, electro-phoretic deposition, tape-casting and calendaring.

Surprisingly it has been found that the small proportion of metal oxides used in the present invention leads to a significant reduction in the temperature required for sintering and densification, without significantly reducing the ionic conductivity of the sintered material.

In some instances the metal oxide particles can be made by thermal decomposition of precursor salts (such as copper (II) nitrate as a precursor for copper oxide, or ferrous nitrate as a precursor for iron oxide) onto the surface of the sodium-ion-conducting ceramic particles, to produce a very fine mixing of the metal oxide, which acts as a sintering aid, and the particles of the sodium-ion-conducting ceramic. The ceramic particles are in the form of a powder, and so this may involve adding an aqueous or alcohol-based solution of the precursor salt to the powder.

Where the transition metal oxides are those of copper, titanium and niobium, the proportion of copper oxide may be greater than that of titanium oxide, while the proportion of titanium oxide may be greater than that of niobium oxide. For example the proportions by weight may be 4:2:1 for the oxides CuO:TiO₂:Nb₂O₅.

Enhanced densification with Nasicon is achieved if the particles of the transition metal oxide or oxides, for example copper, titanium and niobium oxides, or iron oxide, make up no more than 3% of the weight of the particles in the composition, and preferably no more than 2%, but typically more than 0.5%, and optionally more than 1% by weight.

For best results the metal oxide particles should be smaller than the particles of the sodium-ion-conducting ceramic, so they fit into voids between the sodium-ion-conducting ceramic particles during processing to form an electrolyte structure. The particles of metal oxide may be nanopowders, of a size less than 50 nm such as 30 nm or 20 nm, so they are less than a tenth the size of the ceramic particles. The ceramic particles may have a monomodal particle size distribution with a D95 of less than 2 μm, for example about 1 μm. The D50 for these particles may be less than 0.5 μm, for example about 0.40 or 0.35 μm. The particles of metal oxide preferably have a median size less than a tenth that of the particles of sodium-ion-conducting ceramic. This ensures good packing of the ceramic particles, with the metal oxide particles being small enough to fit in the gaps between ceramic particles.

Producing the transition metal oxides in situ from a precursor can provide the benefits of both uniform distribution of the transition metal oxide particles around all the ceramic particles, and very small nano-size particles of the oxide. For example iron oxide particles may be made by heating ferrous nitrate, and the resulting iron oxide particles may be smaller than 10 nm.

To ensure densification, the mixture of the ceramic particles and the metal oxide particles, once formed into the desired shape (such as a pellet or a layer), is subjected to consolidation for example by compression, before being fired. Preferably this achieves a green density between 50% and 65% of full density, or even more. Consolidation ensures that a high green density is achieved before firing, so avoiding residual porosity and also the formation of cracks during sintering.

In a second aspect, the invention provides an electrolyte structure formed by sintering the aforesaid composition to achieve densification.

The invention also provides an electrolyte structure comprising a densified sodium-ion-conducting ceramic that includes at least one transition metal oxide that makes up no more than 5% by weight of the electrolyte structure. The structure consists of particles of the sodium-ion-conducting ceramic with transition metal oxide at the interfaces between adjacent particles of ceramic. The transition metal oxide may for example be iron oxide, or a combination such as copper, titanium and niobium oxides.

The electrolyte may be supported by or deposited onto a metal sheet or foil with holes or perforations. The electrolyte may comprise a porous layer formed on the perforated metal sheet, and an impermeable layer formed on the opposite face of the porous layer. Alternatively there may be a plurality of ceramic layers, with progressively lower levels of porosity, covered by an impermeable layer. For example there may be three layers of ceramic: a porous layer formed on the perforated metal sheet, a less-porous layer formed on the outer surface of the porous layer, and an impermeable layer formed on the outer surface of the less-porous layer. The different degrees of porosity can be obtained using different sizes of the ceramic particles, and different proportions of the transition metal oxides.

The invention will now be further and more particularly described, by way of example only, and with reference to the accompanying drawings in which:

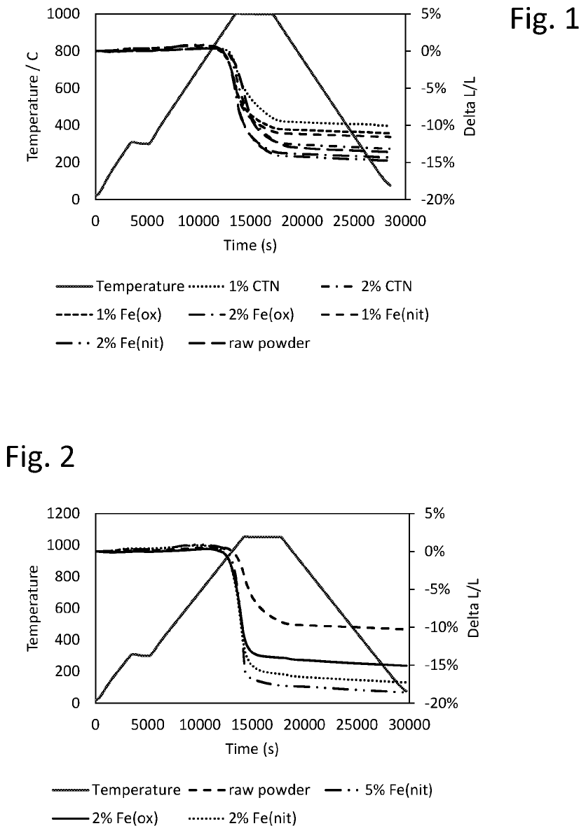

FIG. 1 shows dilatometry data for pellets of various compositions sintered up to 1000° C.;

FIG. 2 shows dilatometry data for pellets of various compositions sintered up to 1050° C.;

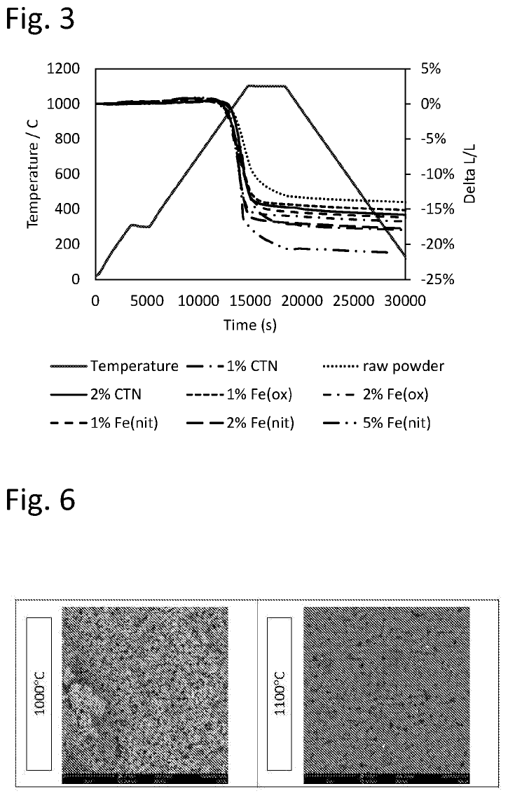

FIG. 3 shows dilatometry data for pellets of various compositions sintered up to 1100° C.;

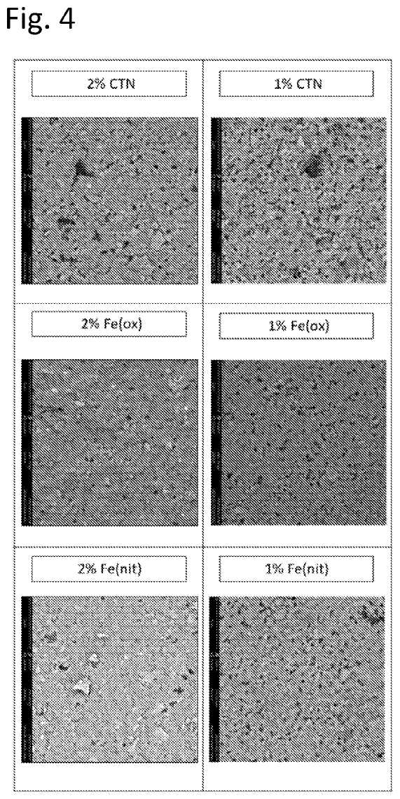

FIG. 4 shows images of fracture surfaces of Nasicon pellets sintered up to 1000° C. for 1 hour, with oxide sintering aid additions, at a magnification ×10,000;

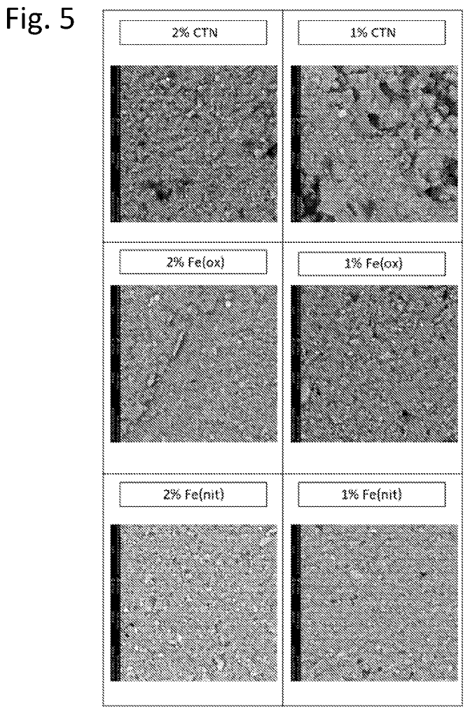

FIG. 5 shows images of fracture surfaces of Nasicon pellets sintered up to 1100° C. for 1 hour, with oxide sintering aid additions, at a magnification ×10,000;

FIG. 6 shows images of fracture surfaces of Nasicon pellets sintered up to 1000° C. and 1100° C. for 1 hour without oxide sintering aid additions, at a magnification ×10,000;

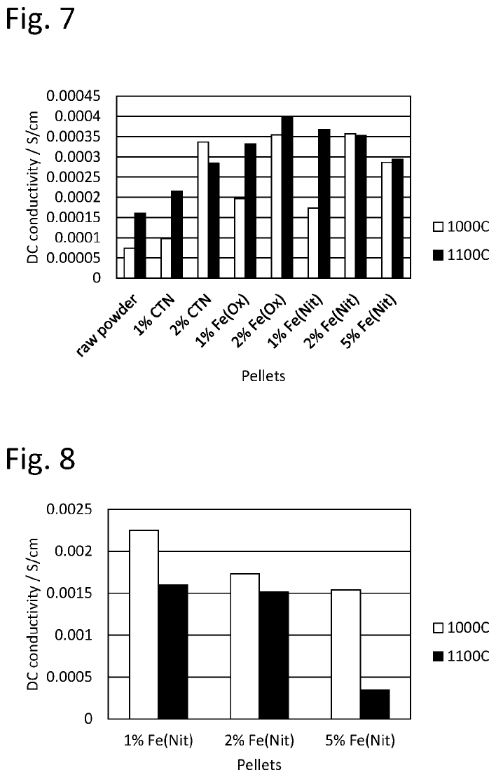

FIG. 7 shows measurements of DC conductivity for Nasicon pellets of different compositions, at room temperature;

FIG. 8 shows measurements of DC conductivity for Nasicon pellets of different compositions, at 250° C.;

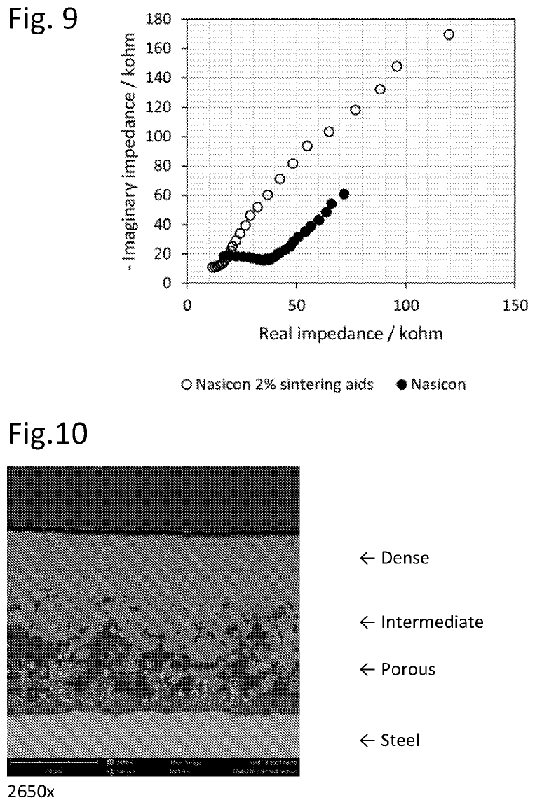

FIG. 9 shows graphically the electrical impedance data as a Nyquist plot, showing the variation of imaginary impedance with real impedance, for pellets of Nasicon produced with and without sintering aids; and

FIG. 10 shows a sectional view of a Nasicon electrolyte fabricated on FeCralloy steel using Nasicon with a 2% Fe (nitrate decomposition route) sintering aid.

### EXAMPLE 1—BASE Layer

Electrolyte layers based on β″-alumina were prepared by forming a slurry containing propan-2-ol and particles of β″-alumina of average size 1.3 μm. This slurry is spread onto a suitable substrate, dried, consolidated, and then sintered. For experimental purposes, pellets of the same electrolyte material were made with the same composition, the composition being dried, formed into a pellet in a die, then compressed and then sintered in the same way as for the layer on a substrate. In one case a mixture of metal oxide nanoparticles, containing nanoparticles of copper oxide (CuO), of titanium dioxide (TiO₂) and of niobium oxide (Nb₂O₅) in weight proportions 4:2:1 was included in the slurry, and constituted 5% of the solid matter by weight.

In each case the sintering took place at 1100° C. for one hour; this temperature is about 500° C. less than the usual sintering temperature for β″-alumina. After this sintering treatment it was found that the specimens that contained only β″-alumina showed no signs of densification, being only about 50% dense. In contrast, the specimens that contained both β″-alumina and the mixture of metal oxides had achieved about 72% densification. These densification measurements were made on the pellets as it is hard to do quantitatively on the layers. The effect on the layer is still clear in this case as the ceramic powder with no sinter aids is essentially still a loose powder that can be removed from the steel substrate easily, whilst the ceramic powder provided with sinter aids is well adhered and has strength.

### EXAMPLE 2—NASICON LAYER

Electrolyte layers based on Nasicon of the composition Na₃Zr₂(SiO₄)₂(PO₄) were prepared by forming a slurry containing propan-2-ol and particles of Nasicon. The Nasicon material had been milled to give a powder with a monomodal size distribution with a d50 less than 1 micron, in this case the d50 being 0.36 microns, as this enhances packing and sinterability.

For experimental purposes, pellets of the same electrolyte material were made in substantially the same way, with the same composition, except that the composition was dried, and then formed into a pellet in a die, before being compressed and then sintered in the same way as for the layer on the substrate. Sintering was assessed by use of a dilatometer which measures shrinkage of the pellet during the sintering process. In three cases a mixture of metal oxide nanoparticles, containing nanoparticles of copper oxide (CuO), of titanium dioxide (TiO₂) and of niobium oxide (Nb₂O₅) in weight proportions 4:2:1 was included in the slurry; in one case this oxide mixture constituted 5% of the solid matter by weight, in another case the metal oxide particles constituted 2% by weight, and in the other case 1% by weight. These examples are referred to as CTN in Table 1 below and other captions.

In a further three cases iron oxide was added by a precursor decomposition route (0.05 M to 0.5 M iron nitrate in propan-2-ol subsequently decomposed to form the oxide at) <300° ° C.; in one case this iron oxide yielded a mixture of 5% of the solid matter by weight, in another case the iron oxide particles constituted 2% by weight, and in the other case 1% by weight. In a final two cases iron oxide was added as iron oxide nanoparticles of size about 20 nm; in one case this oxide mixture constituted 2% of the solid matter by weight and in the other case 1% by weight.

Sintering was performed by ramping the temperature up to a maximum, holding it at that maximum for one hour, and then ramping down again. This was carried out with maximum temperatures of 1000°, 1050° or 1100° ° C. to determine optimal temperatures; these temperatures are about 100° ° C. to 200° ° C. less than the usual sintering temperature required for full densification of Nasicon—i.e. to achieve no connected porosity. The densification achieved with the pellets is shown in Table 1:

TABLE 1

| | % Densifica- | % Densifica- | % Densifica- |
|---|---|---|---|
| % metal oxides | tion at 1000° C. | tion at 1050° C. | tion at 1100° C. |
| 0 | 71 | 84 | 94 |
| 1% CTN | 89 | | 100 |
| 2% CTN | 95 | | 100 |
| 5% CTN | | | 98.5 |
| 1% Fe oxide | 89 | | 100 |
| (via precursor | | | |
| decomposition) | | | |
| 2% Fe oxide | 100 | 100 | 100 |
| (via precursor | | | |
| decomposition) | | | |
| 5% Fe oxide | 100 | 100 | 100 |
| (via precursor | | | |
| decomposition) | | | |
| 1% Fe oxide | 88 | | 100 |
| (nano powder) | | | |
| 2% Fe oxide | 99 | 100 | 100 |
| (nano powder) | | | |

In addition dilatometry data was obtained in each case to show how the percentage shrinkage varied with temperature during the sintering process. The dilatometry data showing the shrinkage with temperature for these pellets are shown for the three maximum sintering temperatures in FIGS. 1, 2 and 3. In FIGS. 1 and 3 a comparison graph is also included for a raw powder pellet, that is to say a pellet made of the same Nasicon powder as described above, but without any metal oxide sintering aid.

It will thus be appreciated that the provision of a small proportion of the metal oxide mixture improves the densification achieved at this lower temperature; and that best results are obtained at around 2% by mass addition. Closer inspection of the derivatives of the dilatometry curves indicates that the maximum rate of densification is not only increased by the use of transition metal oxide addition but also the temperature at which this occurs is reduced typically by at least 50° C. The metal oxide particles hence act as a sintering aid.

These different results are also evident in the scanning electron microscopy images of FIGS. 4 and 5, showing broken surfaces of Nasicon pellets made from compositions that included between 1% and 2% (wt) of the sintering aids, and FIGS. 6, showing a broken surface of a Nasicon pellet made without provision of a sintering aid. In FIG. 4 you can see that at 1000° C. (a very low sintering temperature) there are very few pores visible between particles of ceramic; in FIG. 5 after sintering up to 1100° C. there is negligible porosity between the particles of Nasicon. In contrast, in FIG. 6 you can see the material is very porous particularly in the case for the pellet sintered at 1000° C.

Impedance testing was then carried out at room temperature on Nasicon pellets made in this way. The data was obtained at room temperature (FIG. 7) and at 250° C. (FIG. 8) using an electrochemical impedance analyser working between 7 MHz and 100 Hz giving clear and repeatable impedance spectra. FIG. 7 also shows the data for a pellet made with raw powder, i.e. without any metal oxide sintering aid, and this is labelled as raw powder.

FIG. 7 shows the values of DC conductivity for Nasicon pellets with a range of different sintering aids, sintered at 1000° C. and 1100° C., measured at room temperature, while FIG. 8 shows the values of DC conductivity for such Nasicon pellets with different sintering aids, but measured at 250° C.

Measurements of real and imaginary impedance, i.e. resistance and reactance, were made at a range of different frequencies on a Nasicon pellet without sintering aid (11.68 mm diameter and 2.16 mm thick), and on a Nasicon pellet made with 2% (wt) of the CNT sintering aid (9.39 mm diameter and 1.93 mm thick), and the results are shown graphically in FIG. 9 as a Nyquist plot, the measurements shown by black circles being for the pellet without sintering aid, and the results shown by white circles being for the pellet made with the sintering aid.

These measurements are in line with literature values for Nasicon and suggest that there is no significant detriment to the sodium ion conductivity with the level of doping with the metal oxide sintering aids at 1 and 2% and only a small detrimental impact at 5%. In fact apparent impedance overall appears lower due to the enhanced densification but the shape of the Nyquist spectra produced (example given in FIG. 9) would suggest that there has been some slight increase in impedance (reduction in conductivity), if like for like densification were compared. It is anticipated that the slight reduction in conductivity could be because the lower sintering temperature produces a structure that has much finer grains. The sintering aids pin grain boundaries and significantly increase densification as compared to other sintering mechanisms, such as grain growth. The conductivity of a material is a combination of both the bulk and grain boundary components, it is thus anticipated that materials sintered at lower temperature have a larger proportion of grain boundary resistivity to the total resistivity. Therefore, the reduction in conductivity is not considered to be due to a material interaction with the sintering aid, but rather to having a fundamentally different microstructure. This is beneficial, as the sintering aid ensures all grains are similar in size (homogeneous) and are small, which makes the ceramic significantly tougher and more durable in operation. The potential for negative impact on the conductivity of the Nasicon is possibly mitigated by the fact that all the sintering aids (iron, copper, titanium and niobium oxides) are viable substitutions into the Nasicon structure to form phases with sodium ion conductivity (Journal of Power Sources 273 (2015) 1056-1064).

As mentioned above, an electrode may comprise a layer of sodium-ion-conducting electrolyte supported by or bonded to a perforated metal sheet. The metal of which the perforated sheet is formed must be “inert” in the sense that it does not react chemically with components of the cell with which it is in contact during use; it may for example be a metal such as nickel, or aluminium-bearing ferritic steel (such as the type known as Fecralloy™), or a steel that forms an electronically-conductive and adherent scale, for example a CrMn oxide scale, when heated in air. The adhesion of the ceramic to the metal may be better when using a metal alloy such as Fecralloy that forms an oxide coating of alumina. The perforated sheet may be of thickness no more than 1.0 mm, or no more than 0.5 mm, for example 0.1 mm or 0.2 mm. The sheet is perforated so it has a very large number of through holes, and the perforations or holes may be of mean diameter less than 50 μm, for example 30 μm or less, or of mean diameter between 50 μm and 300 μm, and may for example be produced by a laser drilling process or by chemical etching. The through holes may have their centres spaced apart at between 100 μm and 500 μm, for example 150 μm. Such layers fabricated on Fecralloy steel at a firing temperature of 1050° C. for 1 hour, using Nasicon with 2% iron oxide as sintering aid produced by in situ ferrous nitrate decomposition, have been found to be smooth and coherent and firmly bonded to the metal surface, and are densified sufficiently to give helium permeability readings in the range of 1×10⁻⁰⁸ to 3×10⁻⁰⁷ mbar L/s which is sufficiently leak tight for successful cell operation.

The perforated sheet may have a margin around its periphery that is not perforated; this margin may make it easier to seal the periphery of the perforated plate to adjacent components of the cell. This margin may be of width no more than 15 mm, for example 10 mm or 5 mm or 3 mm.

The electrode may comprise a layer of sodium-ion-conducting electrolyte bonded to a perforated metal sheet, with a porous ceramic layer between the metal sheet and the impermeable sodium-ion-conducting layer.

There may be more than one such porous layer, for example a first porous layer on the metal surface, covered by a less porous layer, and finally covered by an impermeable layer. The different degrees of porosity and permeability can be achieved by using ceramic particles of different sizes, and different amounts of transition metal sintering aids. The first porous layer may for example be deposited by screen printing, the mixture of particles also including binders and flow-aids; the binders and flow-aids would be burned out at the start of the sintering process during a binder burn out step typically 300° C., or below. The subsequent layer or layers may be deposited by spray coating, screen printing or electrophoretic deposition.

An example of such a layered structure is shown in FIG. 10, which is a scanning electron micrograph showing a cross-section. The electrolyte has three layers of Nasicon. The first, most porous layer was deposited by a screen printing process where the Nasicon particle size used in the ink had a D95 of 16.6 μm. This layer was formed in a single print and drying process followed by a 1000° ° C. firing for 1 hour to give a strong but porous layer that was well adhered to the substrate Fecralloy steel. Onto this was spray coated a layer with an intermediate particle size with a D95 of 4.7 μm to form a structure with finer interconnected porosity. This layer contained 2% wt iron oxide added via the precursor decomposition route; it was consolidated under an applied pressure and fired at 1000° C. for 1 hour to produce a strong and well adhered but still porous layer. Finally, onto this layer was spray coated a layer with a fine particle size with a 2% wt iron oxide addition added via the precursor decomposition route with the same specification as used in the pellet densification studies described above. This layer was then fired at 1050° C. for 1 hour and gave a dense and impermeable layer.

1. A composition for forming a sodium-ion conducting electrolyte structure, comprising particles of a Nasicon sodium-ion-conducting ceramic, and particles of at least one transition metal oxide, or at least one precursor for a transition metal oxide, so the transition metal oxide or oxides make up no more than 5% by weight of the weight of the particles, wherein the particles are of iron oxide, or the particles are of copper, titanium and niobium oxides, or the precursor is a precursor for iron oxide, or the precursors are precursors for copper, titanium and niobium oxides.

2. (canceled)

3. The composition of claim 1 wherein the metal oxides comprise oxides of copper, titanium and niobium, and the proportion of copper oxide is greater than that of titanium oxide, while the proportion of titanium oxide is greater than that of niobium oxide.

4. (canceled)

5. The composition of claim 3, wherein the proportions by weight of the oxides CuO:TiO₂:Nb₂O₅ are in the ratios 4:2:1.

6. (canceled)

7. The composition of claim 1, wherein the metal oxide particles make up no more than 3% of the weight of the particles in the composition.

8. The composition as claimed in claim 7 wherein the metal oxide particles make up no more than 2% of the weight of the particles in the composition.

9. The composition of claim 1, wherein the metal oxide particles have a smaller median size than the particles of the sodium-ion-conducting ceramic, so they fit into voids between the sodium-ion-conducting ceramic particles during processing to form an electrolyte structure.

10. The composition of claim 1, wherein the particles of metal oxide are nanopowders, with a median size less than a tenth that of the particles of sodium-ion-conducting ceramic.

11. The composition of claim 10, wherein the metal oxide particles are made by thermal decomposition of precursor salts onto the surface of the particles of sodium-ion-conducting ceramic.

12. An electrolyte structure formed by sintering a composition as claimed in claim 1, to form a sodium-ion-conducting sintered ceramic.

13. (canceled)

14. (canceled)

15. The electrolyte structure of claim 12, also comprising a perforated metal sheet to support the sintered sodium-ion-conducting ceramic.

16. The electrolyte structure as claimed in claim 10, further comprising a porous layer formed on the perforated metal sheet, and an impermeable layer formed on the opposite face of the porous layer.

17. The electrolyte structure as claimed in claim 10, further comprising at least three ceramic layers formed on the perforated metal sheet, the ceramic layers having progressively lower levels of porosity, the last such layer being an impermeable layer.
